(19) United States
(12) Patent Application Publication
(10) Pub. No.: US 2022/0010577 A1
(43) Pub. Date: Jan. 13, 2022

(54) DEVICE AND METHOD FOR RELEASING A STRESSING STRAND

(71) Applicant: Wobben Properties GmbH, Aurich (DE)

(72) Inventor: Lars GOTTSCHALK, Gerwisch (DE)

(21) Appl. No.: 17/427,486

(22) PCT Filed: Feb. 4, 2020
(86) PCT No.: PCT/EP2020/052653

§ 371 Date: Jul. 30, 2021

(30) Foreign Application Priority Data
Feb. 4, 2019 (DE) 10 2019 102 688.1

(51) Int. Cl. E04H 12/16

(52) U.S. Cl. CPC E04H 12/16

(57) ABSTRACT

An apparatus and a method for relieving a tension strand, in particular a tension strand of a prestressed tower, preferably a prestressed concrete tower of a wind power plant. Furthermore, the disclosure relates to a method for dismantling a prestressed tower and to the use of an apparatus. The apparatus comprises a first anchoring unit with a first tension strand receptacle for a first section of the tension strand, a second anchoring unit with a second tension strand receptacle for a second section of the tension strand, and a lifting unit which is configured to change a spacing between the first and second anchoring unit.

### BACKGROUND

### Technical Field

The invention relates to an apparatus and a method for relieving a tension wire, in particular a tension strand of a prestressed tower, preferably of a prestressed concrete tower of a wind power plant. Furthermore, the invention relates to a method for dismantling a prestressed tower, and to the use of an apparatus and a method for relieving a tension strand.

### Description of the Related Art

In concrete structures which are under high load, tendons are frequently used to prestress the structures. Here, in particular, externally guided tendons are also used which do not run within concrete components, for example in the interior of cladding tubes encased in concrete, but rather run adjacently to or in an adjoining manner with respect to the concrete components. In the case of towers which consist of concrete or comprise concrete, in particular, externally guided tendons are used. For example, towers can be produced from cast-in-place concrete or from precast concrete parts. In the case of concrete towers of this type, tendons are often used, in order to prestress the tower in the longitudinal direction.

A tendon as a rule comprises a plurality of tension strands, and can therefore also be called a tension strand bundle. A tendon can have, for example, up to twenty tension strands, for example fifteen tension strands. A tension strand as a rule comprises a plurality of wires. For example, a tension strand can be constructed from seven wires, six wires being wound about a central wire. A tension strand can also comprise more or fewer than seven wires, however. The wires of a tension strand are as a rule arranged within a sheath of the tension strand, which sheath can comprise or consist of, for example, plastic, in particular HDPE. A lubricant, such as grease, for example, is as a rule arranged within the tension strand sheath and around the wires and between the wires. The individual wires can be preferably configured from solid material, as a rule metal, in particular steel, and can have, for example, a diameter of a few mm (millimeters), for example from 5 to 6 mm.

The tension strands of a tendon as a rule run in parallel over a large part of their length, and are often anchored at their ends via common anchor apparatuses. In order to prestress concrete towers, the tendons with the tension strands are as a rule anchored at the tower head and at the tower foundation, and are then provided with a corresponding prestressing force. In the case of towers with an annular cross section, the externally guided tendons are often also arranged in an annular manner, and usually run in the interior of the tower. The tension strands of the tendons are then as a rule accessible from the interior of the tower.

Prestressed concrete towers are frequently used in the case of wind power plants. Here, a nacelle with an aerodynamic rotor is placed onto the tower.

In the case of structures with externally guided tendons, it can be necessary for different reasons for the tension strands of the tendons to be relieved or to be removed, for example in the case of structure restoration. In particular if the anchorings of the tendons with their tension strands at the foundation and/or at the tower head cannot be released or cannot be released in a controlled manner, it can become necessary for individual tension strands, a plurality of tension strands are all the tension strands to be severed between the anchorings. Since the tension strands in the case of highly loaded prestressed structures are as a rule under high tension which can be, for example, 200 kN per tension strand in the case of prestressed concrete towers and can bring about tension strand elongations of, for example, 80 cm, the releasing or severing of tension strands is complicated and associated with risks. On account of the high tensioning force and tension strand elongations, suddenly springing back of the tension strands or other uncontrolled movements of the tension strands can occur in the case of the release or severing of tension strands. As a result, firstly considerable risks for people and the structures can arise, and secondly cost risks can occur.

The German Patent and Trade Mark Office has searched the following prior art in the priority application in respect of the present application: U.S. Pat. No. 5,289,326 A, DE 195 36 700 A1, and US 2013/0205686 A1.

### BRIEF SUMMARY

Provided is an improved apparatus and an improved method for relieving a tension strand, which apparatus and method reduce or eliminate one or more of the abovementioned disadvantages. In particular, provided is an apparatus and a method for relieving a tension strand, which apparatus and method are simplified and/or improved with regard to the occupational safety and/or process safety and/or efficiency and/or reliability.

Provided is an apparatus for relieving a tension strand, in particular a tension strand of a prestressed tower, preferably of a prestressed concrete tower of a wind energy plant, the apparatus comprising a first anchoring unit with a first tension strand receptacle for a first section of the tension strand, a second anchoring unit with a second tension strand receptacle for a second section of the tension strand, and a lifting unit which is configured to change a spacing between the first and second anchoring unit.

The apparatus which is described herein serves to relieve tension strands, in particular tension strands which are under tension. The tension strands to be relieved can be, in particular, part of a tension strand bundle or a tendon. The tensioning forces which occur in tension strands, in particular of tendons for prestressing concrete towers of wind energy plants, can be, for example, at least 50 kN or at least 75 kN or at least 100 kN or at least 120 kN. The tensioning forces which occur in tension strands, in particular of tendons for prestressing concrete towers of wind power plants, can be, for example, above or up to 150 kN or above or up to 175 kN or above or up to 200 kN or above or up to 250 kN. The tension strand elongations which occur in tension strands, in particular of tendons for prestressing concrete towers of wind power plants, can be, for example, at least 5 cm or at least 10 cm or at least 50 cm or at least 75 cm. The tension strand elongations which occur in tension strands, in particular of tendons for prestressing concrete towers of wind power plants, can be, for example, above or up to 80 cm or above or up to 100 cm or above or up to 150 cm or above or up to 175 cm or above or up to 200 cm or above or up to 250 cm.

The apparatus has two anchoring units which are spaced apart from one another. Said anchoring units are part of the apparatus which is described herein for relieving tension strands, and serve to temporarily receive sections of a tension strand to be relieved. Said anchoring units of the apparatus for relieving tension strands are therefore to be differentiated from the anchor apparatuses, by way of which the tendons which are also called tension strand bundles are anchored at the foundation and/or at the tower head, for example, of a tower of a wind power plant for the regular operating duration of the tower.

The spacing between the first and second anchoring unit of the apparatus for relieving tension strands preferably extends parallel to the longitudinal axis of the tension strand which is to be relieved. The longitudinal axis of the tension strand can also be called the tension strand axis. The first and second anchoring unit in each case have a first and second tension strand receptacle. In said tension strand receptacles, a first and second section of the tension strand can be arranged and received. The tension strand receptacles preferably have a longitudinal axis which runs parallel to or is identical with the longitudinal axis of the tension strand to be relieved. The first and second sections of the tension strands are preferably spaced apart from one another substantially at the same spacing as the two anchoring units.

Furthermore, the apparatus has a lifting unit. The lifting unit is preferably connected to the first and the second anchoring unit. The lifting unit serves to change the spacing between the first and the second anchoring unit.

The tension strand receptacles of the anchoring units serve, in particular, to receive the tension strand sections in the anchoring units and to anchor them there. Anchoring by means of the anchoring units is understood here, in particular, to mean fastening which is preferably releasable and/or temporary, and prevents a relative displacement between the tension strand section and the anchoring unit, in particular along the direction of the tension strand axis, in particular also in the case of the application of high forces which can correspond to the prevailing tensioning forces or can exceed the latter.

By way of the apparatus which is described herein, it becomes possible for a tension strand to be relieved in a safe and controlled manner between the two anchoring units. Said tension strand sections which are spaced apart are held by way of the receiving and anchoring of the tension strand sections in the tension strand receptacles of the anchoring units. If the spacing between the anchoring units is then changed by way of the lifting unit, in particular is decreased, relieving of the tension strands between the two anchoring units can be achieved. As a result, the severing of the tension strands between the two anchoring units can take place in a completely or virtually completely relieved state, which considerably minimizes the risks and increases the safety. The receiving and anchoring of the tension strand sections in the tension strand receptacles of the anchoring units has the advantage, furthermore, that only relatively small parts of the tension strands, namely the length of the tension strands between the two anchoring units, are subjected, in the case of severing of the tension strands between the anchoring units, to a movement on account of an existing residual tension in the tension strands in the case of severing. Risks can be also reduced and the safety can also be increased by way of this.

All the tension strands of a tension strand bundle and/or the tension strands of all tendons of a prestressed concrete tower can preferably be relieved and severed by means of the apparatus, it being possible for the severing of individual tension strands to take place one after another.

It is provided in accordance with one preferred embodiment that the lifting unit is configured to increase and/or to decrease the spacing between the first and second anchoring unit.

In particular, a decrease in the spacing between the first and second anchoring unit can lead to relieving of the tension strand between the two anchoring units. An increase in the spacing between the first and second anchoring unit can lead, in particular, to relieving of the tensioning strands in regions outside the apparatus, that is to say on the other side of the anchoring units. It is thus preferred, for example, that the apparatus is used to first of all decreases the spacing between the first and second anchoring unit, in order for it to be possible for the tension strand to be relieved between the two anchoring units and to be severed there. Subsequently, it is preferred for the spacing between the first and second anchoring unit to be increased, in order then to relieve the tension strand which is now severed in the regions outside the apparatus, that is say, for example, above and below the anchoring units. If the apparatus is then dismantled, that is to say the tension strand sections are released from the tension strand receptacles of the anchoring units, the tension strand is preferably already completely relieved, with the result that no uncontrolled movements of the severed tension strand take place.

Furthermore, it is preferred that the lifting unit connects the first and second anchoring unit and/or is arranged between the first and second anchoring unit.

One preferred development is distinguished by the fact that the lifting unit is configured as a hydraulic cylinder or as a spindle lifting mechanism.

Said arrangements and configurations of the lifting unit have the advantage that a unit of this type is particularly suitable for applying the required high forces, in order to overcome the tensioning forces of the tension strands, for example of from approximately 50 to approximately 250 kN per strand, in the case of changing of the spacing between the two anchoring units.

It is provided in a further preferred embodiment that the first anchoring unit is configured in two pieces, and/or in that the second anchoring unit is configured in two pieces. It is preferred here, in particular, that the first tension strand receptacle is configured in two pieces, and/or that the second tension strand receptacle is configured in two pieces. Furthermore, it is preferably provided that the first anchoring unit has a first anchor base and a first anchor plate, and/or that the second anchoring unit has a second anchor base and a second anchor plate.

A two-piece configuration of the anchoring units and, in particular, of the tension strand receptacles has the advantage that receiving of the tension strand sections in the tension strand receptacles of the anchoring units can be facilitated. A two-piece configuration by means of an anchor base and an anchor plate represents a reliable and at the same time simple construction for this purpose. The tension strand receptacle is preferably arranged centrally in the anchor base and/or the anchor plate. Furthermore, the first tension strand receptacle is preferably formed by the first anchor base and the first anchor plate, and/or the second tension strand receptacle is formed by the second anchor base and the second anchor plate.

Furthermore, it is preferred that the first anchor plate is fastened releasably to the first anchor base, preferably by means of a screw connection, and/or that the second anchor plate is fastened releasably to the second anchor base, preferably by means of a screw connection.

A releasable fastening of the anchor plate to the anchor base allows simple opening of the anchoring units and preferably also of the tension strand receptacles, with the result that receiving of the tension strands in the tension strand receptacles is simplified further. The releasable fastening of the anchor plate to the anchor base can take place, for example, via fastening elements, such as Allen screws. A plurality of fastening elements on the two sides of a tension strand receptacle are preferably provided.

Controlled and reliable anchoring can take place via a screw connection of this type of an anchor plate to the anchor base, in particular in the case of an arrangement of fastening elements, such as screws, on the two sides of the tension strand section to be received, for example via the torques which are to be applied to the screw connection.

It is provided in accordance with one preferred embodiment that the first anchoring unit has a length, a width and a depth, the depth preferably being multiple times smaller than the width and/or the length, and/or the second anchoring unit has a length, a width and a depth, the depth preferably being multiple times smaller than the width and/or the length.

The length of the first and/or the second anchoring unit is preferably orthogonal with respect to a plane which is defined by the width and depth. The width of the first and/or the second anchoring unit is preferably orthogonal to a plane which is defined by the length and depth. The depth of the first and/or the second anchoring unit is preferably orthogonal to a plane which is defined by the length and width. The length of the first and/or the second anchoring unit preferably extends in a direction parallel to the tension strand axis. The width and depth of the first and/or the second anchoring unit preferably extend in a direction orthogonally with respect to the tension strand axis.

A small depth of the first and/or the second anchoring unit has the advantage that the first and/or the second anchoring unit can thus also be used in constricted installation spaces. In particular, it is preferred that the depth is dimensioned in such a way that it is smaller than a spacing between two adjacent tension strands and/or smaller than a spacing between a tension strand and a tower wall, in particular a tower inner wall. The spacing preferably extends orthogonally with respect to a tension strand axis, and can denote the spacing between two adjacent tension strands in the normal installed and/or operating state or can comprise an extended spacing, in the case of which one tension strand has been lifted from an adjacent tension strand or a plurality of adjacent tension strands of a tension strand bundle, for example by means of an air cushion.

It is preferred, in particular, that the depth is at most 10 cm, preferably at most 5 cm, in particular at most 4 cm.

A further preferred development is distinguished by the fact that the first anchoring unit has a first clamping unit, the first clamping unit preferably being arranged at least in sections in the first tension strand receptacle, and/or is characterized by the fact that the second anchoring unit has a second clamping unit, the second clamping unit preferably being arranged at least in sections in the second tension strand receptacle.

The tensioning units can preferably be configured as a clamping wedge, the clamping wedge preferably being configured to receive a tension strand. A longitudinal axis of the clamping wedge is preferably oriented parallel to the tension strand axis. The clamping units serve, in particular, to improve the anchoring of the tension strand, which is arranged in the tension strand receptacles, in the anchoring unit.

Further advantageous design variants of the above-described apparatus result by way of combination of the preferred features which are explained herein.

In accordance with a further aspect, the object mentioned at the outset is achieved by way of a method for relieving a tension strand, in particular a tension strand of a prestressed tower, preferably of a prestressed concrete tower of a wind power plant, comprising: arranging of a first section of the tension strand in a first tension strand receptacle and anchoring of the first section of the tension strand in a first anchoring unit, arranging of a second section of the tension strand in a second tension strand receptacle and anchoring of the second section of the tension strand in a second anchoring unit, and changing of a spacing between the first and second anchoring unit by means of a lifting unit.

The above-described method can preferably be developed by way of increasing a spacing of the tension strand with respect to an adjacent tension strand and/or with respect to a tower wall, preferably by means of an air cushion.

Furthermore, the method is distinguished by way of a decrease of the spacing between the first and second anchoring unit.

The decrease in the spacing between the first and second anchoring unit is preferably at most 3 cm, in particular at most 1 cm. The spacing between the first and second anchoring unit is preferably decreased to such an extent that the tension strand is completely or virtually completely relieved between the first and second anchoring unit.

The above-described method can preferably be developed, furthermore, by way of severing of the tension strand between the first and second anchoring unit.

Furthermore, it is preferred that the method comprises increasing the spacing between the first and second anchoring unit.

An increase in the spacing between the first and second anchoring unit is preferably at least 10 cm, in particular at least 50 cm. In particular, the increase in the spacing between the first and second anchoring unit serves to reduce or to eliminate the tension in the tension strand outside the apparatus.

The method preferably also comprises the release of the anchoring of the tension strand sections in the anchoring units, and the removal of the apparatus.

In accordance with a further aspect, provided is a method for dismantling a prestressed tower, preferably a prestressed concrete tower of a wind power plant, comprising: relieving of at least one tension strand, preferably of a plurality of tension strands, in particular of all the tension strands, by means of an above-described apparatus and/or by means of an above-described method for relieving a tension strand, and removing of the tension strand and/or of tower segments.

In accordance with a further aspect, provided is the use of an above-described apparatus for relieving a tension strand of a prestressed tower, in particular of a prestressed tower of a wind power plant.

Said further aspects have features or method steps which make them suitable, in particular, to be used with an above-described apparatus and its developments. In respect of the advantages, design variants and embodiment details of said further aspects and their developments, reference is made to the preceding description in respect of the corresponding apparatus features.

### BRIEF DESCRIPTION OF THE SEVERAL VIEWS OF THE DRAWINGS

Preferred exemplary embodiments will be described by way of example on the basis of the appended figures, in which:

FIG. 1 shows a diagrammatic illustration of a wind power plant,

FIG. 2 shows a view of a first exemplary apparatus for relieving a tension strand,

FIG. 3 shows a view of the apparatus according to FIG. 2 with a severed tension strand,

FIG. 4 shows a plan view of the apparatus according to FIGS. 2 and 3,

FIG. 5 shows a view of a further exemplary apparatus for relieving a tension strand, and

FIG. 6 shows a diagrammatic flow chart of an exemplary method for relieving a tension strand.

### DETAILED DESCRIPTION

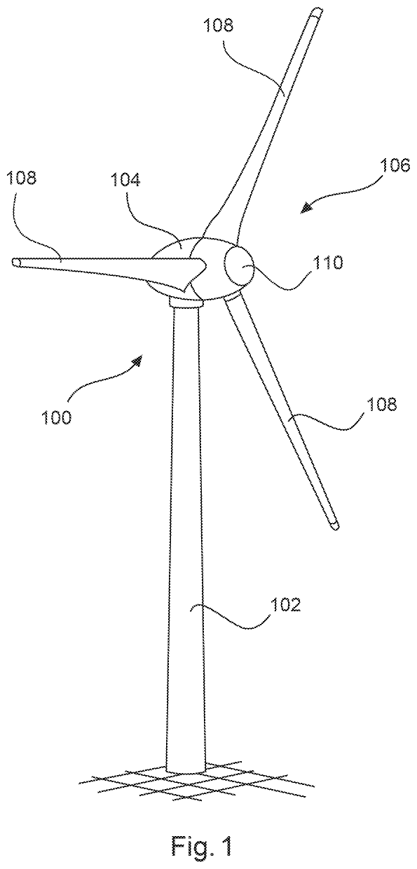

FIG. 1 shows a diagrammatic illustration of a wind power plant. The wind power plant 100 has a tower 102 and a nacelle 104 on the tower 102. An aerodynamic rotor 106 with three rotor blades 108 and a spinner 110 is provided on the nacelle 104. During operation of the wind power plant, the aerodynamic rotor 106 is set in a rotational movement by way of the wind, and therefore also drives an electrodynamic rotor of a generator which is coupled directly or indirectly to the aerodynamic rotor 106. The electric generator is arranged in the nacelle 104 and generates electric energy. The pitch angles of the rotor blades 108 can be changed by way of pitch motors at the rotor blade roots of the respective rotor blades 108.

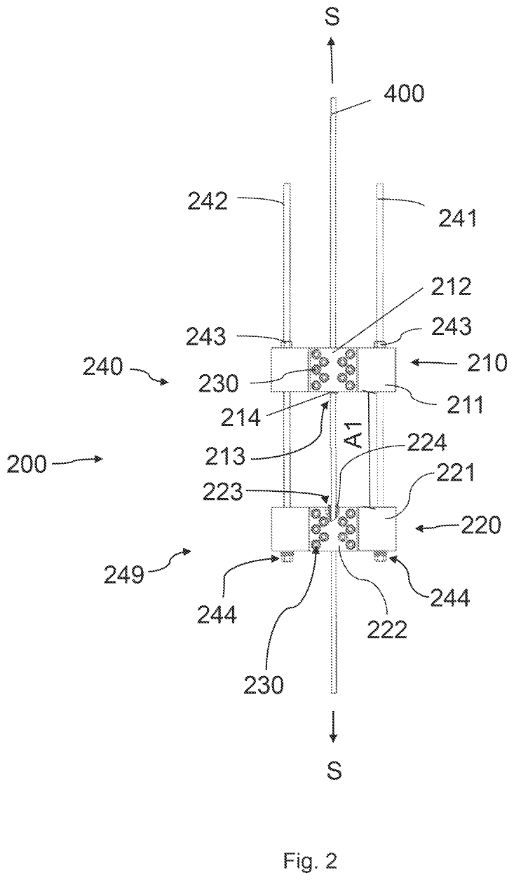

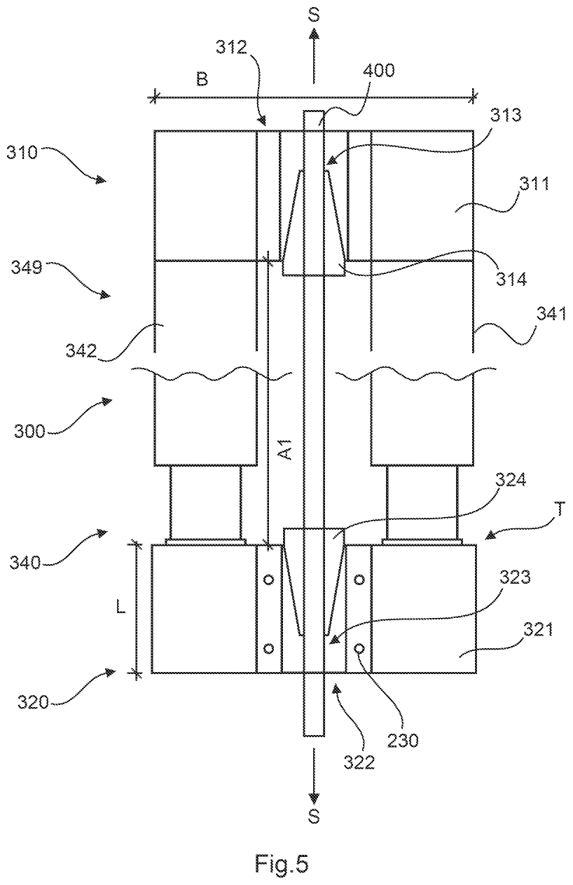

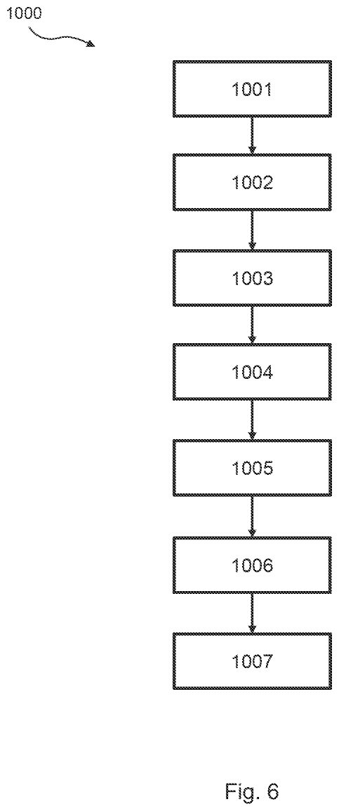

The tower 102 is a prestressed concrete tower with tendons which are guided externally in the interior of the tower 102 and in each case have a plurality of tension strands. In order to relieve tension strands of this type, an apparatus for relieving a tension strand can be used, as described, for example, in FIGS. 2 to 4 and in FIG. 5, a method according to FIG. 6 preferably being used.

In the figures, identical or substantially functionally identical elements are provided with the same designations. General descriptions relate as a rule to all embodiments in so far as differences are not explicitly specified.

The exemplary embodiments described herein of the apparatus 200, 300 serve to relieve tension strands 400 which are under tension, for example with tensioning forces S of from approximately 50 kN (kilonewtons) to approximately 250 kN and/or tension strand elongations of from approximately 10 cm (centimeters) to approximately 250 cm.

The apparatus 200 which is shown in FIGS. 2 to 4 comprises a first anchoring unit 210 with a first tension strand receptacle 213 for a first section of the tension strand 400, and a second anchoring unit 220 with a second tension strand receptacle 223 for a second section of the tension strand 400.

FIG. 5 shows a further apparatus 300 with a first anchoring unit 310 with a first tension strand receptacle 313 for a first section of the tension strand 400, and a second anchoring unit 320 with a second tension strand receptacle 323 for a second section of the tension strand 400.

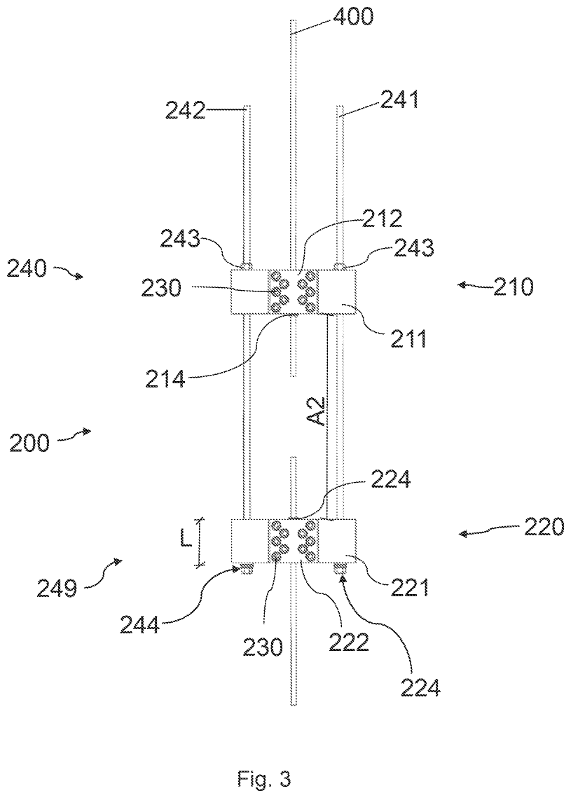

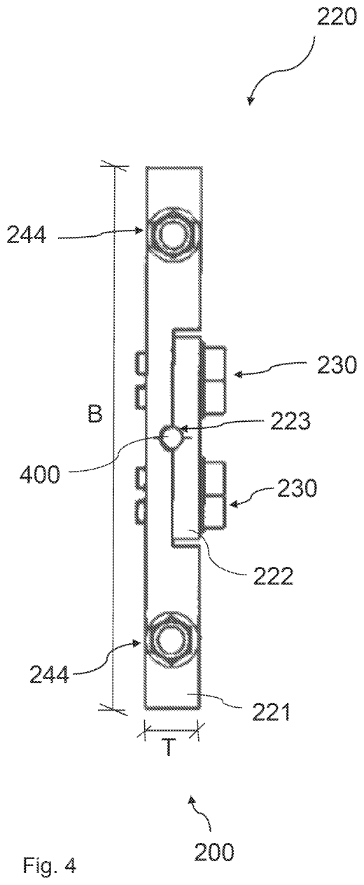

The respective two anchoring units 210, 220, 310, 320 are spaced apart from one another. The spacing A1 between the first and second anchoring unit 210, 220, 310, 320 extends parallel to the longitudinal axis of the tension strand 400. In FIGS. 2 and 4, the tension strand has not yet been severed, and the anchoring units 210, 220, 310, 320 are spaced apart from one another at the small spacing A1, the spacing A1 preferably already having been decreased, with the result that the tension strand between the anchoring units 210, 220, 310, 320 is already completely or largely relieved. In FIG. 3, the tension strand 400 is severed, the anchoring units 210, 220 have been removed from one another by means of the lifting unit 240 and they are now spaced apart at the greater spacing A2, with the result that the tension strand is also relieved outside the apparatus 200, in particular above the first anchoring unit 210 and below the second anchoring unit 220.

The tension strand receptacles 213, 223, 313, 323 also in each case have a longitudinal axis which runs parallel to or is identical to the longitudinal axis of the tension strand 400 to be relieved. The two anchoring units 210, 220, 310, 320 in each case have a clamping unit in the form of clamping wedges 214, 224, 314, 324. The longitudinal axes of the clamping wedges 214, 224, 314, 324 are also oriented parallel to the tension strand axis. The clamping wedges 214, 224, 314, 324 serve to improve the anchoring of the tension strand 400, which is arranged in the tension strand receptacles 213, 223, 313, 323, in the anchoring units 210, 220, 310, 320.

The anchoring units 210, 220, 310, 320 with their tension strand receptacles 213, 223, 313, 323 are configured in two pieces, and in each case have an anchor base and an anchor plate, the tension strand receptacle 213, 223, 313, 323 being formed by the anchor base and the anchor plate. The tension strand sections can thus be received simply in the tension strand receptacles 213, 223, 313, 323 of the anchoring units 210, 220, 310, 320. The tension strand receptacle 213, 223, 313, 323 is arranged in each case centrally in the anchor base 212, 222, 312, 322 and the anchor plate 212, 222, 312, 322. The anchor plate 212, 222, 312, 322 is fastened releasably to the anchor base 212, 222, 312, 322 by means of a screw connection via a plurality of Allen screws 230 which are provided on the two sides of the tension strand receptacle 213, 223, 313, 323. As a result, the anchoring units 210, 220, 310, 320 and tension strand receptacles 213, 223, 313, 323 can be opened simply, and controlled and reliable anchoring can take place, for example via the torques which are to be applied to the screw connection.

The anchoring units 210, 220, 310, 320 in each case have a length L, a width B and a depth T, the depth T being multiple times smaller than the width B and the length L. It is preferred, in particular, that the depth T is at most 10 cm, preferably at most 5 cm, in particular at most 4 cm.

A small depth of the anchoring units 210, 220, 310, 320 has the advantage that the anchoring units 210, 220, 310, 320 can be inserted between adjacent tension strands and/or between the tension strand and the tower inner wall, it being possible for the tension strand 400 to be relieved to be raised beforehand from the adjacent tension strands or the tower inner wall, for example by means of an air cushion.

The tension strand sections are received and anchored in the tension strand receptacles 213, 223, 313, 323 of the anchoring units 210, 220, 310, 320. An anchoring is a fastening which prevents a relative displacement between the tension strand sections and the respective anchoring unit 210, 220, 310, 320, in particular along the direction of the tension strand axis, in particular also in the case of the application of high forces which can correspond to the prevailing tensioning forces S or can exceed the latter.

Furthermore, the apparatus 200 has a lifting unit 240 in the form of a spindle lifting mechanism 249. The lifting unit 340 of the apparatus 300 is configured as a hydraulic cylinder 349.

The spindle lifting mechanism 249 according to FIGS. 2 to 4 has two threaded spindles 241, 242 which are connected via axial bearings 244 to the second anchoring unit 220 and run through nuts 243 which are connected fixedly to the first anchoring unit 210. The spacing A1, A2 between the anchoring units 210, 220 can be changed by way of the application of torques to the threaded spindles 241, 242 via the axial bearings 244.

The hydraulic cylinder 349 according to FIG. 5 has two hydraulic cylinders 341, 342 which are connected to the first and second anchoring unit 310, 320. By way of actuating, in particular retracting and extending of the hydraulic cylinders 341, 342, the spacing A1 between the anchoring units 310, 320 can be changed.

The lifting units 240, 340 are configured to change a spacing A1, A2 between the first and second anchoring unit 210, 220, 310, 320, in particular to increase it and/or to decrease it. The lifting units 240, 340 are arranged between the first and second anchoring unit 210, 220, 310, 320, and are connected to the first and the second anchoring unit 210, 220, 310, 320. The lifting units 240, 340 are suitable to apply the required high forces, in order to overcome the tensioning forces of the tension strand 400, for example of from approximately 50 to approximately 250 kN per strand, in the case of the change of the spacing A1, A2 between the two anchoring units 210, 220, 310, 320.

A decrease in the spacing between the first and second anchoring unit 210, 220, 310, 320 to the spacing A1 leads to relieving of the tensioning strand 400 between the two anchoring units 210, 220, 310, 320. An increase in the spacing between the first and second anchoring unit 210, 220, 310, 320 to the spacing A2 leads to relieving of the tensioning strand 400 in regions outside the apparatus 200, 300, that is to say on the other side of the anchoring units 210, 220, 310, 320.

The apparatus 200, 300 is used initially to first of all decrease the spacing between the first and second anchoring unit 210, 220, 310, 320 to the spacing A1, in order to relieve the tension strand 400 between the two anchoring units 210, 220, 310, 320, as is shown in FIG. 2, in particular. The tension strand 400 can then be severed. After the severing, the spacing between the first and second anchoring unit 210, 220, 310, 320 is increased to the spacing A12, in order to relieve the tension strand 400 which is then severed in the regions outside the apparatus 200, 300, that is to say, for example, above and below the anchoring units 210, 220, 310, 320, as is shown in FIG. 3, in particular. If the apparatus is then dismantled, that is to say the tension strand sections are released from the tension strand receptacles 213, 223, 313, 323 of the anchoring units 210, 220, 310, 320, the tension strand 400 is preferably already completely relieved, with the result that no uncontrolled movements of the severed tension strand 400 take place.

This takes place, in particular, by way of a method 1000 for relieving a tension strand 400, which method 1000 can proceed as follows. As preparation, an increase 1004 in a spacing of the tension strand from an adjacent tension strand and/or from a tower wall preferably takes place, preferably by means of an air cushion. Then, arranging 1002 of the first section of the tension strand 400 in a first tension strand receptacle 213, 313 and anchoring of the first section of the tension strand 400 in a first anchoring unit 310, 310 take place first of all, and then arranging 1002 of a second section of the tension strand in a second tension strand receptacle 223, 323 and anchoring of the second section of the tension strand 400 in a second anchoring unit 220, 320 take place. Changing 1003 of a spacing between the first and second anchoring units 210, 220, 310, 320 by means of a lifting unit 240, 340 then takes place, and, in particular, a decrease 1004 in the spacing between the first and second anchoring unit 210, 220, 310, 320. The decrease in the spacing between the first and second anchoring unit 210, 220, 310, 320 is preferably at most 3 cm, in particular at most 1 cm. The spacing between the first and second anchoring unit 210, 220, 310, 320 is preferably decreased to such an extent that the tension strand 400 is relieved completely or virtually completely between the first and second anchoring unit 210, 220, 310, 320. Severing 1005 of the tension strand 400 then takes place between the first and second anchoring unit 210, 220, 310, 320, and an increase 1006 in the spacing between the first and second anchoring unit 210, 220, 310, 320 subsequently takes place. An increase in the spacing between the first and second anchoring unit 210, 220, 310, 320 is preferably at least 10 cm, in particular at least 50 cm. In particular, the increase in the spacing between the first and second anchoring unit 210, 220, 310, 320 serves to reduce or to eliminate the tension S in the tension strand 400 outside the apparatus 200, 300. Finally, a release 1007 of the anchoring of the tension strand sections in the anchoring units 210, 220, 310, 320 takes place, and the removing of the apparatus 200, 300 takes place.

A method for dismantling a prestressed concrete tower 102 of a wind power plant 100 preferably results if, after relieving of at least one tension strand 400, preferably a plurality of tensioning strands, in particular all the tensioning strands, by means of the apparatus 200, 300 and/or by means of the method 1000 for relieving a tension strand 400, the tension strand 400 or the tension strands are removed, in particular after severing, and/or tower segments are removed. For example, prefabricated parts of a concrete tower can be placed onto one another, with or without joint connection means. The prefabricated parts can then be removed successively, optionally after severing of the joints, in order to dismantle the tower.

The apparatuses 200, 300 make it possible for a tension strand 400 between the respective two anchoring units 210, 220, 310, 320 to be relieved and severed safely and in a controlled manner, and subsequently for the tension strand outside the apparatuses 200, 300, in particular outside the two anchoring units 210, 220, 310, 320, to be relieved. The risks and costs during the dismantling of externally prestressed structures, in particular concrete towers of wind power plants, can thus be reduced considerably, and the safety can be increased.

1. An apparatus for relieving a tension strand of a prestressed tower of a wind power plant the apparatus comprising:
a first anchoring unit with a first tension strand receptacle for receiving a first section of the tension strand,
a second anchoring unit with a second tension strand receptacle for receiving a second section of the tension strand,
a lifting unit configured to change a spacing between the first and second anchoring units.

2. The apparatus as claimed in claim 1, wherein the lifting unit is configured to increase and/or decrease the spacing between the first and second anchoring units.

3. The apparatus as claimed in claim 1, wherein the lifting unit connects the first and second anchoring units and is arranged between the first and second anchoring units.

4. The apparatus as claimed in claim 1 wherein the lifting unit is a hydraulic cylinder or a spindle lifting mechanism.

5. The apparatus as claimed in claim 1 wherein at least one of the first anchoring unit or the second anchoring unit is configured in two pieces.

6. The apparatus as claimed in claim 1 wherein at least one of the first anchoring unit or the second anchoring unit has a first anchor base and a first anchor plate.

7. The apparatus as claimed in claim 1 wherein at least one of the first anchoring unit and the second anchoring unit has a length, a width, and a depth, the depth being multiple times smaller than the width and/or the length.

8. The apparatus as claimed in claim 1 wherein at least one of the first anchoring unit or the second anchoring unit has a first clamping unit, the first clamping unit and the second anchoring unit being arranged at least in sections in the first and second tension strand receptacles, respectively.

9. A method for relieving a tension strand of a prestressed tower of a wind power plant, the method comprising:
arranging a first section of the tension strand in a first tension strand receptacle, and anchoring the first section of the tension strand in a first anchoring unit,
arranging a second section of the tension strand in a second tension strand receptacle, and anchoring the second section of the tension strand in a second anchoring unit, and
changing a spacing between the first and second anchoring units using a lifting unit.

10. The method as claimed in claim 9, wherein changing the spacing between the first and second anchoring units using the lifting unit comprises increasing a spacing of the tension strand with respect to an adjacent tension strand and/or with respect to a tower wall.

11. The method as claimed in claim 9, wherein changing the spacing between the first and second anchoring units using the lifting unit comprises decreasing the spacing between the first and second anchoring unit.

12. The method as claimed in claim 9, further comprises severing of the tension strand between the first and second anchoring units.

13. The method as claimed in claim 9, further increasing the spacing between the first and second anchoring units.

14. A method for dismantling a prestressed tower of a wind power plant, the method comprising:
relieving of at least one tension strand using the apparatus as claimed in claim 1; and
removing the at least one tension strand and/or tower segments.

15. (canceled)

16. The method as claimed in claim 14, wherein the at least one tension strand is a plurality of tension strands.

17. The apparatus as claimed in claim 1 wherein the prestressed tower is a prestressed concrete tower of the wind power plant.

18. The method as claimed in claim 10, wherein increasing the spacing of the tension strand comprises using an air cushion.
